(19) United States
(12) Patent Application Publication
(10) Pub. No.: US 2023/0057846 A1
(43) Pub. Date: Feb. 23, 2023

(54) IDENTIFYING ITEMS FOR A USER USING MACHINE LEARNING

(71) Applicant: Capital One Services, LLC, McLean, VA (US)

(72) Inventors: Jonathan RICKLIS, Richardson, TX (US); Gerardo FANG, El Paso, TX (US)

(73) Assignee: Capital One Services, LLC, McLean, VA (US)

(21) Appl. No.: 17/405,521

(22) Filed: Aug. 18, 2021

(51) Int. Cl. G06F 40/279; G06F 40/205; G06F 16/9535; G06Q 30/06

(52) U.S. Cl. CPC G06F 40/279; G06F 40/205; G06F 16/9535; G06Q 30/0631

(57) ABSTRACT

The method, system, and non-transitory computer-readable medium embodiments described herein identifying items for a user. In a given embodiment, a server receives item ownership data for a user and user information. The item ownership data indicates an item currently or previously owned by the user. The server receives a string about the item provided by the user. Using the string, the server identifies subjective data about the item and identifies a set of items based on the item ownership data and the subjective data. Furthermore, the server detects a subset of items from the set of items based on availability of the subset of items and the user information. The server transmits the identified subset of items to a device.

### BACKGROUND

Predicting user preferences and identifying a preferred item for a user often involves multiple different elements. For example, a user may need to consider the various attributes of an item. Furthermore, the user may also need to consider price and affordability information when identifying the preferred item. The user's preferred item may change over time based on the user's needs and circumstances. However, conventional systems fail to consider the different elements when recommending an item to the user. As a result, the user may spend an extensive amount of time searching for the preferred item. This can be an error-prone process and operationally costly.

### BRIEF DESCRIPTION OF THE DRAWINGS

The accompanying drawings are incorporated herein and form a part of the specification.

FIG. 1 is a block diagram of a system for identifying items for a user, according to some embodiments, according to some embodiments.

FIG. 2 is a block diagram illustrating components of the system for identifying items for the user, according to some embodiments, according to some embodiments.

FIG. 3 illustrates a webpage for providing user vehicle ownership history and subjective data regarding the previously owned items, according to some embodiments.

FIG. 4 is a flowchart illustrating a process for identifying items for a user, according to some embodiments.

FIG. 5 is a flowchart illustrating a process for generating a score for each item identified for a user, according to some embodiments.

FIG. 6 is a flowchart illustrating a process for identifying a trend attribute, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, updating and validating data stored in a database.

As described above, identifying a preferred item involves multiple different elements. These items may include retail products, vehicles, houses, etc. The user may need to consider price, affordability, and loan qualification information when identifying the preferred item. The different elements may change over time as the user's circumstances, needs, and preferences change. Conventional systems fail to consider the different elements involved in identifying the preferred item. Furthermore, conventional systems fail to consider the user's changing circumstances, needs, and preferences. Therefore, identifying the preferred item can be an error-prone process and operationally costly.

Embodiments described herein solve these problems by capturing a user's sentiment data regarding their current and previously owned items. In a given embodiment, a server receives item ownership data for a user and user information. The item ownership data indicates an item currently or previously owned by the user. The server receives a string about the item provided by the user. The server identifies subjective data about the item from the string. Moreover, the server identifies user preference data based on the item ownership data and the user information using a machine learning algorithm. The server identifies a set of items based on the item ownership data, the subjective data, and the user preference data. The server identifies a subset of items from the set of items, based on the availability of the subset of items. The server transmits the identified subset of items to a device.

The embodiments described herein allow for identification of a preferred subset of vehicles that may be of interest to the user based on the user's vehicle ownership data, user's sentiment data regarding the previously owned vehicles, and the availability of vehicles at car dealerships. In this way, the embodiments described herein accurately assess the user's current circumstances, needs, and preferences, allowing for efficiently and accurately identifying the user's preferred vehicles. As a result, the user and/or a car dealership will not expend unnecessary operational resources identifying the user's preferred vehicles.

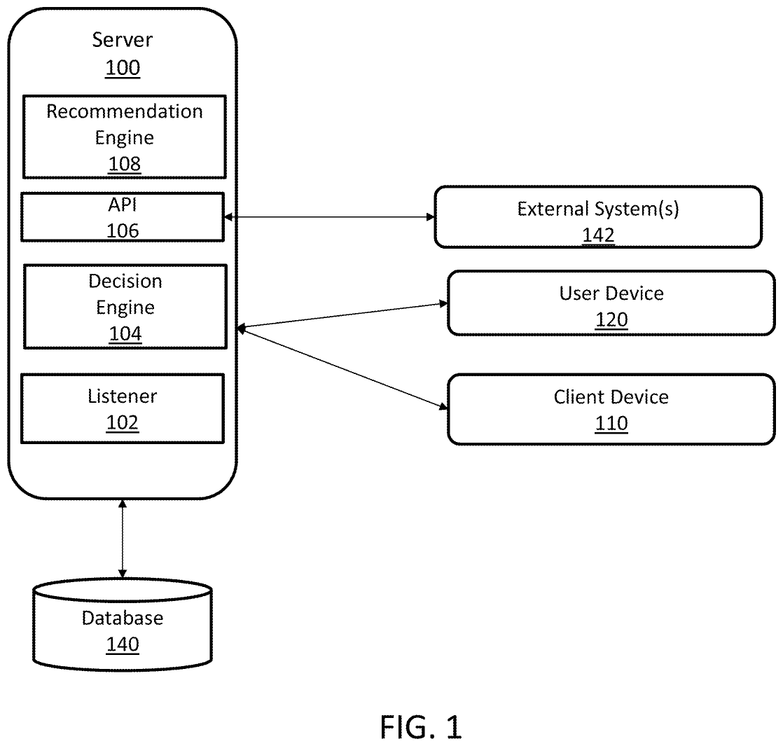

FIG. 1 is a block diagram of a system for identifying items for a user, according to some embodiments. In an embodiment, the system can include a server 100, client device 110, user device 120, database 140, and external system(s) 142. Server 100 may communicate with client device 110, user device, 120, and database 140. Furthermore, server 100 may communicate with external system(s) 142 via API(s) 106.

The devices of the system for identifying items for users can be connected through wired connections, wireless connections, or a combination of wired and wireless connections. As an example, the devices can be connected through a network. The network can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

In a given embodiment, client device 110 and user device 120 may interface with server 100 to identify items of interest to a user. For example, client device 110 may be operated by a third-party, such as a car dealership, and user device 120 may be operated by a user, such as a potential customer. Client device 110 and user device 120 may transmit item ownership data and user information to server 100. The item ownership data may include data regarding items currently and previously owned by the user. Client device 110 and user device 120 may also transmit a string including subjective data regarding the items currently and previously owned by the user to server 100. The subjective data may be user sentiment data.

Server 100 may include a listener 102 and decision engine 104. Decision engine 104 may implement one or more machine learning algorithms to identify items of interest to the user. For example, decision engine 104 may implement a natural language processing (NLP) algorithm to identify the subject data from the string regarding the item previously owned by the server. The NLP algorithm may be one or more of word embeddings, super vector machines, Bayesian networks, deep learning, etc.

Server 100 may store the subjective data regarding the item previously owned by the user in database 140. Database 140 may be one or more data storage devices configured to store a user's historical item ownership information and the user's subjective data regarding the previously owned items.

Server 100 may interface with external system 142 using API 106 to identify items that may be of interest to the user based on the historical data about an item owned by the user, subjective data, and user information. API 106 may be one or more APIs that interface with external system 142. External system 142 may be one or more external systems, such as government institutions (e.g., department of motor vehicles (DMV)), sellers (e.g., car dealerships), financial institutions, or the like.

Server 100 may use API 106 to retrieve information such as seller inventory information, the user's item ownership data, loan pricing information, etc. Server 100 may identify information about items that may be of interest to a user based on the retrieved information (e.g., seller inventory information, the user's item ownership data, loan pricing information, etc.). Server 100 may store the information about the items that may be of interest to the user in database 140.

Listener 102 may be an event listener configured to detect events, such as items becoming available at one or more sellers that may be of interest to the user. Listener 102 may use API 106 to detect items available at the one or more sellers that match the one or more elements of the information about the items that may be of interest to the user. Listener 102 may transmit the information about the detected items to client device 110 or user device 120.

As indicated above, client device 110 may be operated by a seller, such as a car dealership. As such, the information about the detected items may be leads for potential sales. Furthermore, user device 120 may be operated by a user, such as a customer. The information about the detected items may be recommendations of items to purchase for the user.

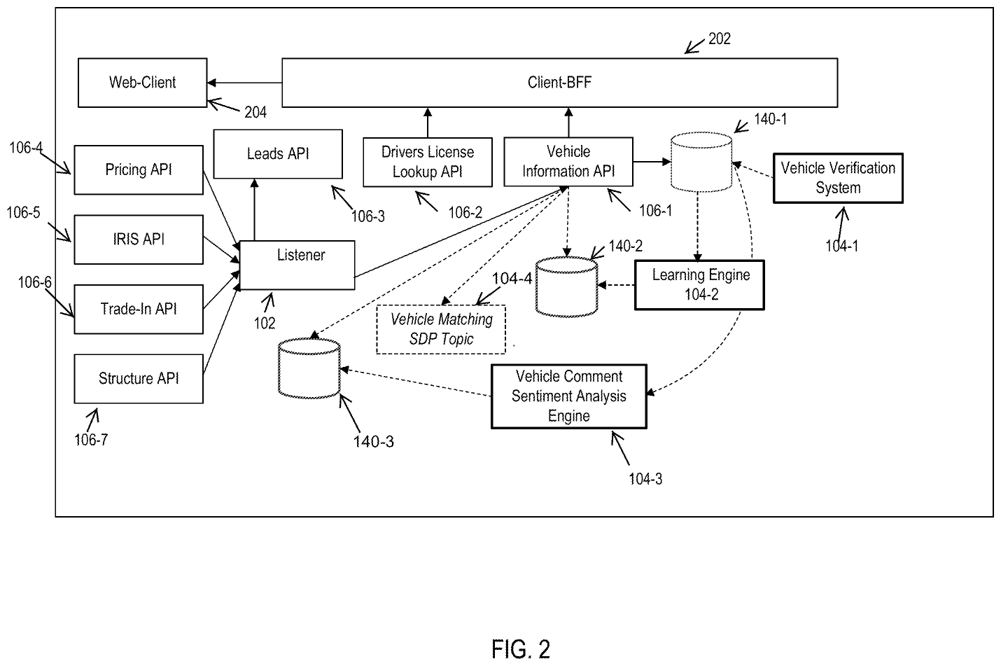

FIG. 2 is a block diagram illustrating components of the system for identifying items for a user, according to some embodiments. FIG. 2 illustrates components for identifying vehicles for a user; however, FIG. 2 is not limited to identifying vehicles. FIG. 2 shall be described with reference to FIG. 1.

In a given embodiment, server 100 may include a client backend-for-frontend (BFF) 202, web-client 204, vehicle information API 106-1, driver license lookup API 106-2, leads API 106-3, pricing API 106-4, IRIS API 106-5, trade-in API 106-6, structure API 106-7, listener 102, vehicle verification system 104-1, learning engine 104-2, vehicle verification system 104-3, vehicle comment sentiment analysis engine 104-4, and vehicle matching SDP topic 104-5.

Server 100 may communicate with data storage devices 140-1-140-3. Data storage device 140-1 may store user information, including financing preferences, personal information (e.g., name, date of birth, identification number, etc.), address information, employment information, and vehicle ownership history. Data storage device 140-2 may store vehicle inventory information across multiple dealerships. Data storage device 140-3 may include the user's subjective data regarding the user's previously owned vehicles.

API 106 may include vehicle information API 106-1, driver license lookup API 106-2, leads API 106-3, pricing API 106-4, IRIS API 106-5, trade-in API 106-6, and structure API 106-7. Database 140 may include data storage devices 140-1-140-3. Decision engine 104 may include vehicle verification system 104-1, learning engine 104-2, vehicle verification system 104-3, vehicle comment sentiment analysis engine 104-4, and vehicle matching SDP topic 104-5.

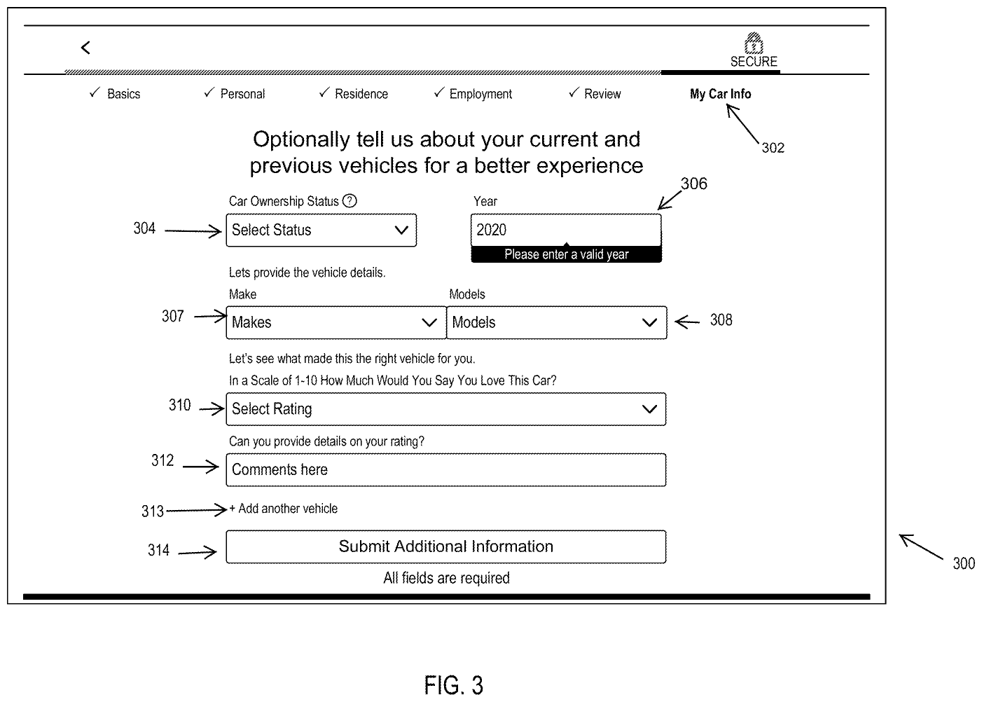

Server 100 may provide a web-client 204 to client device 110 and user device 120. Web-client 204 may be an interface provided via the website. Client device 110 or user device 120 may access the interface using the website. A seller (e.g., car dealership) or a user (e.g., potential customer) may interface with the website to provide the user's vehicle ownership history and subjective data regarding the previously owned vehicles. This is illustrated in FIG. 3.

FIG. 3 illustrate a webpage 300 for providing user vehicle ownership history and subjective data regarding the previously owned items, according to some embodiments. FIG. 3 illustrates webpage 300 as part of the website for identifying vehicles for the user. The website for identifying vehicles for the user may collect information such as user information. The user information may include basic information about their financing preferences, personal information (e.g., name, date of birth, identification number, etc.), address information, employment information. The website for identifying vehicles for the user may include multiple tabs for collecting the information, including basics, personal, residence, employment, review, and the “My Car Info” tab 302.

Webpage 300 is part of the “My Car Info” tab 302. Webpage 300 may include input fields 304-312. Each of input fields 304-312 may be a dropdown menu or a text box, for example. Input fields 304-312 may be used to input information about the user's current and previously owned vehicles. Input field 304 may be used to indicate the user's current car ownership status. Input field 304 may be a dropdown menu including options such as “current vehicle” or “previously owned vehicle.” Input field 306 may be used to indicate the year of the user's current or previously owned vehicle. Input fields 307-308 may be used to indicate the user's current or previously owned vehicle's make and model.

Input field 310 may be used to indicate the user's rating of their current or previously owned vehicle. The rating may be on a scale of 1-10, where the rating indicates the user's level of satisfaction with their current or previously owned vehicle.

Input field 312 may be used to input a comment regarding their current or previously owned vehicle. Input field 312 may be a text box that is configured to accept a string. Users may input a string, such as “My current car is spacious. I love it.” Alternatively, users may input a string, such as “My car is old. I hate it!” The string may include subjective data. The subjective data may be the user's sentiment data regarding their current or previously owned vehicle.

The user may select button 313 to input information about other previously owned vehicles. In response to selecting button 313, input fields 304-312 may be rendered for inputting information about the other previously owned vehicles.

The user may select button 314 to input additional information. The additional information may include information about the type of vehicle the user is attempting to purchase. This can include make, model, size, type, price range, color, etc.

The user may submit the information input on the website for identifying vehicles for the user, including the information input in the input fields 304-312. The information input on the website for identifying vehicles for the user may be transmitted to server 100.

Returning to FIG. 2, server 100 may receive the information input on the website for identifying vehicles via client BFF 202. The information input on the website may include user information and the user's current and previously owned vehicles. The client BFF 202 may be a shim configured to interface with the website, the micro-services, and APIs in server 100 to identify vehicles for the user. Client BFF 202 may interface with vehicle information API 106-1 to retrieve information about the user's current and previously owned vehicles. Vehicle information API 106-1 may store the user information and the information about the user's current and previously owned vehicles in data storage device 140-1.

Vehicle verification system 104-1 may verify the user's vehicle ownership history. For example, the user information may include the user's driver's license number or another identification number (e.g., social security number). Vehicle verification system 104-1 may use driver license lookup API 106-2 to lookup the user's vehicle ownership history from a government institution (e.g., DMV, country/state records, etc.). Driver license lookup API 106-2 may use the user's driver's license number or another identification number to retrieve the user's vehicle ownership history information from the government institution's system. Driver license lookup API 106-2 may store the retrieved vehicle ownership history information in data storage device 140-1.

Vehicle verification system 104-1 may verify the user's current and previously owned vehicles provided by the user on the website against the user's vehicle ownership history retrieved by driver license lookup API 106-2. Vehicle verification system 104-1 may delete any erroneous information regarding the user's current and previously owned vehicles based on the verification.

Learning engine 104-2 may be configured to implement one or more machine-learning algorithms to identify user preference data based on information regarding the user's current and previously owned vehicles, and user information. For example, learning engine 104-2 may ingest information about the user from data storage device 140-1. The information about the user may include the information about the user received from the website, including financing preferences, personal information (e.g., name, date of birth, identification number, etc.), address information, and employment information. The information also about the user also includes the information about the user's current and previously owned vehicles, as verified by vehicle verification system 104-1.

Learning engine 104-2 may implement one or more machine learning algorithms to identify vehicles commonly sold by car dealerships based on the information about the user's current and previously owned vehicles. Learning engine 104-2 may be configured to train and deploy machine learning models. For example, learning engine 104-2 may implement supervised learning algorithms, unsupervised learning algorithms, textual analysis, or image processing. Supervised learning algorithms may include Factorization Machines Algorithm, K-Nearest Neighbors (k-NN) Algorithm, Linear Learner Algorithm, XGBoost Algorithm, DeepAR Forecasting Algorithm, etc. Unsupervised learning algorithms may include Principal Component Analysis (PCA) Algorithm, Random Cut Forest (RCF) Algorithm, IP Insights, Object2Vec Algorithm, K-Means Algorithm, Latent Dirichlet Allocation (LDA) Algorithm, Neural Topic Model (NTM) Algorithm, etc. Textual analysis may include BlazingText Algorithm, Sequence-to-Sequence Algorithm, etc. Image processing may include Image Classification Algorithm, Object Detection Algorithm, Semantic Segmentation Algorithm, etc.

Learning engine 104-2 may parse the user's current vehicle and/or previously owned vehicles into individual elements. For example, the elements may include make, model, year, mileage, price, color, size, type, ownership duration, financing method, etc.

Learning engine 104-2 may determine that certain elements are more important to the user than other elements based on the information about the user's current and previously owned vehicles, and the user information. For example, learning engine 104-2 may identify similarities across the user's current and previously owned vehicles. Learning engine 104-2 may determine the user preference data based on the identified similarities. In light of this, learning engine 104-2 may assign weights to each of the elements of the user's current vehicle and/or previously owned vehicles based on the importance of the element to the user. Learning engine 104-2 may identify vehicles that include elements that closely match or are similar to the elements which have assigned a greater weight. For example, learning engine 104-2 may determine that the user consistently purchases vehicles of a particular make. Therefore, learning engine 104-2 may assign a greater weight to the “make” element. Learning engine 104-2 may be more likely to then identify vehicles that particular make.

In some embodiments, learning engine 104-2 may also retrieve information about the set of vehicles from data storage device 140-2 based on the user's financing preferences, personal information (e.g., name, date of birth, identification number, etc.), address information, and employment information.

Learning engine 104-2 may interface with data storage device 140-2 to identify a set of vehicles from data storage device 140-2 that include elements that match one or more elements of the user's current and previously owned vehicles. To this end, learning engine 104-2 may identify the set of vehicles based on the determined user preference data.

As described above, the user may also provide a string including subjective data regarding the user's current or previously owned vehicles. The string may be stored in data storage device 140-1. Vehicle comment sentiment analysis engine 104-3 may implement an NLP algorithm to analyze the string to identify the subjective data regarding the user's current and previously owned vehicles. For example, the NLP algorithm may be configured to identify keywords that provide insight regarding the user's subjective data (e.g., sentiment). For example, the words may include “great,” “bad,” “excellent,” “terrible,” or the like. The NLP algorithm may also be configured to identify punctuation to identify the user's subjective data, such as an exclamation mark. Moreover, the NLP algorithm may identify words that are associated with a vehicle, such as, size, color, price, engine, power, etc. The NLP algorithm may identify the user's subjective data using the identified keywords, and words associated with the vehicle.

Vehicle comment sentiment analysis engine 104-3 may identify user preferences regarding elements of the user's current and previously owned vehicles based on the subjective data. The elements may include make, model, size, type, color, year, price, etc. Vehicle comment sentiment analysis engine 104-3 may store the subjective data and the user preferences in data storage device 140-3. The subjective data may be user sentiment data. Vehicle comment sentiment analysis engine 104-3 may filter the set of vehicles retrieved by learning engine 104-2 based on the subjective data.

For example, the user may provide the following string regarding a particular 2019 make of a car, “Great car, but too small.” Vehicle comment sentiment analysis engine 104-3 may detect the phrase “Great, car.” Vehicle comment sentiment analysis engine 104-3 may also detect the phrase “too small.” As a result, vehicle comment sentiment analysis engine 104-3 may determine that the user may be looking for a car similar to the particular make but bigger. Vehicle comment sentiment analysis engine 104-3 may filter out vehicles from the set of vehicles that learning engine 104-2 retrieved from data storage device 140-2 that are a similar size as the particular make or smaller. Vehicle comment sentiment analysis engine 104-3 may filter out vehicles from the set of vehicles that are not similar to the particular make.

Learning engine 104-2 may store information about the set of vehicles, identified based on the user's item ownership data and the subjective data, in data storage device 140-2. Learning engine 104-2 may also calculate a score for each of the vehicles in the set of vehicles indicating the likelihood that the user may purchase the vehicle. For example, learning engine 104-2 may adjust the user preference data based on the subjective data. For example, decision engine 104 may use subjective data regarding the current and previously owned vehicles to identify elements that the user consistently looks for in a vehicle. The user preference data may include information about the elements associated with the vehicle. For example, the user preference data may include preferred make, model, size, color, price, etc. Learning engine 104-2 may use the user preference data to identify elements that may be important to the user.

Learning engine 104-2 may match the elements of each of the set of vehicles to the user preferences regarding the elements. Learning engine 104-2 may calculate a score for each vehicle of the set of vehicles based on the weights assigned to each respective element and a similarity of a match of each respective element of a respective vehicle to the user preferences regarding each respective element. The score for each vehicle may be stored in data storage device 140-2.

Listener 102 may determine that the information about the set of vehicles is stored in data storage device 140-2. In particular, decision engine 104 may publish a vehicle matching topic 104-4. Vehicle matching topic 104-4 may be a message that instructs listener 102 to listen for or detect any vehicles from the set of vehicles that may become available for the user. For example, listener 102 may be subscribed to vehicle matching topic 104-4. Therefore, listener 102 may interface with IRIS API 106-5 to determine whether any of the set of vehicles are available at car dealerships within a threshold radius. IRIS API 106-5 may interface with the systems of various car dealerships to determine whether any vehicles from the set of vehicles are available in the inventory of the respective car dealership.

Listener 102 may also interface with pricing API 106-4 and structure API 106-7 to determine whether the user is prequalified to purchase any of the vehicles in the set of vehicles at a financing structure desirable to the user. As indicated above, the user may provide financing preferences, personal information (e.g., name, date of birth, identification number, etc.), address information, and employment information on the website. The financing preferences may include preferred loan term, financing jointly or as an individual, preferred loan percentage, etc. Pricing 106-4 and structure API 106-7 may interface with systems of one or more financial institutions to determine whether the user is prequalified to purchase any of the vehicles in the set of vehicles at a financing structure desirable to the user.

In some embodiments, listener 102 may use the user information to retrieve the user's current financing structure for a currently owned vehicle. Listener 102 may determine the user's financing preferences and capabilities based on the current financing structure. Listener 102 may interface with pricing 106-4 and structure API 106-7 to generate financing pricing structures for each vehicle of the set of vehicles for the user. Listener 102 may determine whether the user is likely to accept the generated financing pricing structures based on the user's current financing structure and financing preferences.

Listener 102 may interface with trade-in API 106-6 to determine whether any car dealerships or financial institutions are willing to accept a vehicle currently owned by the user for trade-in for any of the vehicles of the subset of vehicles at a value desirable to the user. The user may indicate that they would want to trade in their current vehicle at the desired value to purchase their next vehicle. Therefore, trade-in API 106-6 may interface with systems of car dealerships or financial institutions to determine whether any car dealerships are willing to accept a vehicle currently owned by the user for trade-in for any of the vehicles of the subset of vehicles at a value desirable to the user.

Listener 102 may detect a subset of vehicles from the set of vehicles that are available at one or more car dealerships for purchase, the user is prequalified to purchase at a financing structure desirable to the user, and/or available for trade-in for a vehicle currently owned at a value desirable to the user. As described above, scores may be assigned to each of the one or more vehicles.

Listener 102 may transmit information about the subset of vehicles, the user information, and the corresponding scores to leads API 106-3. Leads API 106 may provide the information about the one or more vehicles, the user information, and corresponding scores to an interface available to client device 110. As indicated above, client device 110 may be operated by car dealerships. As a result, car dealerships may use the interface to identify potential customers and a likelihood that the potential customer will purchase.

Listener 102 may also transmit the information about the subset of vehicles and the user information to vehicle information API 106-1. Vehicle information API 106-1 may store the information about the subset of vehicles in data storage device 140-1. Vehicle information API 106-1 may correlate the information about the subset of vehicles with the user information in data storage device 140-1.

In some embodiments, server 100 may be associated with a financial institution (e.g., a bank). A user may have an online account with the financial institution and the user may log on to their online account. Recommendation engine 108 may detect that a user logged into their online account using their authentication details, and recommendation engine 108 may retrieve the information about the subset of vehicles stored in data storage device 140-1 based on the user information. Recommendation engine 108 may generate a recommendation of the subset of vehicles for the user. Recommendation engine 108 may cause the recommendation of the subset of vehicles to be displayed, for example, in a webpage of the online account. Specifically, recommendation engine 108 causes information about one or more of the subset of vehicles and the car dealerships at which they are available to be displayed on the webpage of the online account.

In some embodiments, data storage device 140-3 may store the user's subjective data regarding the user's current and previously owned vehicles and the user preferences regarding the elements of the user's current and previously owned vehicles. Furthermore, data storage device 140-3 may store other users' subjective data regarding the other users' currently and previously owned vehicles and the user preferences regarding the elements of other users' currently and previously owned vehicles. Decision engine 104 may identify a trend attribute associated with a particular type of vehicle based on the user's subjective data regarding the user's current and previously owned vehicles, the user preferences regarding the elements of the user's current and previously owned vehicles, the other users' subjective data regarding the other users' currently and previously owned vehicles, and the user preferences regarding the elements of other users' currently and previously owned vehicles. For example, decision engine 104 may identify the popularity or unpopularity of a particular vehicle. Moreover, decision engine 104 may identify user preferences regarding elements of a particular vehicle. For example, users may like or dislike a particular vehicle's maintenance, initial quality rating, fuel consumption, performance, comfort, visibility, steering, amenities/options, warranty, etc.

Decision engine 104 may also determine trend attributes related to a particular geographic region based on the user's subjective data regarding the user's current and previously owned vehicles, the user preferences regarding the elements of the user's current and previously owned vehicles, the other users' subjective data regarding the other users' currently and previously owned vehicles, and the user preferences regarding the elements of other users' currently and previously owned vehicles. Decision engine 104 may determine a trend of users preferring a particular vehicle in particular geographic regions and/or preferring particular vehicle elements in particular geographic regions. For example, decision engine 104 may determine that users living in mountainous regions prefer vehicles with all-wheel drive capabilities.

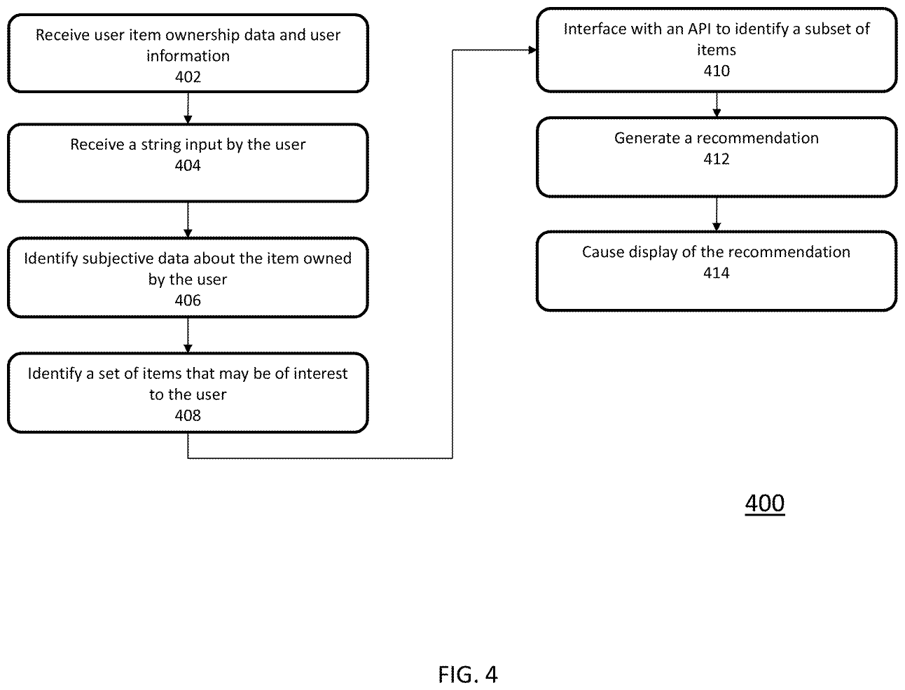

FIG. 4 is a flowchart illustrating a process for identifying items for a user, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 4, as will be understood by a person of ordinary skill in the art.

Method 400 shall be described with reference to FIGS. 1-2. However, method 400 is not limited to those example embodiments.

In operation 402, server 100 receives user item ownership data and user information. For example, server 100 may receive the user item ownership data and user information from a website. A user may provide information about the user's current and previously owned vehicles on the website. Furthermore, the user may provide financing preferences, personal information (e.g., name, date of birth, identification number, etc.), address information, and employment information on the website. Vehicle verification system 104-1 may verify the user's current and previously owned vehicles provided on the website against the user's current and previously owned vehicles retrieved from a government institution's system.

In operation 404, server 100 receives a string input by the user about the item owned by the user from the website. The string may include subjective data regarding the item owned by the user. For example, the string may be “Great car, but too small.”

In operation 406, server 100 identifies the subjective data about the item owned by the user from the string. Server 100 may use an NLP algorithm to identify the subjective data about the item. In particular, server 100 may use NLP to determine the user's sentiment regarding the item owned by the user. Server 100 may determine the user's likes and dislikes with respect to the user's current and previously owned items based on the subjective data.

In operation 408, server 100 identifies a set of items that may be of interest to the user based on the user item ownership data and subjective data. For example, server 100 may match elements of the user's currently and previously owned items with elements of a set of items that may be available for purchase for the user. Furthermore, server 100 may use the subjective data regarding the user's current and previously owned items to identify the user's likes or dislikes regarding elements of the user's current and previously owned items. Server 100 may use the user's likes or dislikes regarding the elements of the user's current and previously owned items to filter the set of items. In some embodiments, in the event server 100 cannot identify a set of items for the user, server 100 may recursively execute operation 408 until server 100 can identify at least one item.

In operation 410, server 100 interfaces with API 106 to identify a subset of items from the set of items to identify a subset of items from the set of items based on the availability of the subset of items and the user information. For example, the items may be vehicles, and listener 102 may detect the subset of vehicles in response to server 100 storing the information about the set of vehicles in data storage device 140-2. In particular, listener 102 may detect the subset from the set of vehicles that are available at a car dealership for purchase, the user is prequalified to purchase at a financing structure desirable to the user and/or available for trade-in for a vehicle currently owned by at a value desirable to the user. Listener 102 may interface with IRIS API 106-5 to determine whether any of the set of vehicles are available at car dealerships. Listener 102 may also interface with pricing API 106-4 and structure API 106-7 to determine whether the user is prequalified to purchase any of the vehicles in the subset of vehicles at a financing structure desirable to the user. Listener 102 may interface with trade-in API 106-6 to determine whether any car dealerships or financial institutions are willing to accept a vehicle currently owned by the user for trade-in for any of the vehicles of the subset of vehicles at a value desirable to the user.

In operation 412, server 100 generates a recommendation of one or more items from the subset of items using the information for the user.

In operation 414, server 100 causes the recommendation of the one or more items to be displayed on user device 120. Server 100 may also transmit the user information to client device 110. Client device 110 may be operated by a seller, such as a car dealership. Listener 102 may transmit information about the subset of items and user information to leads API 106-4. Leads API 106-4 may communicate with an interface that provides potential leads of customers and the items that may be of interest to the potential customers.

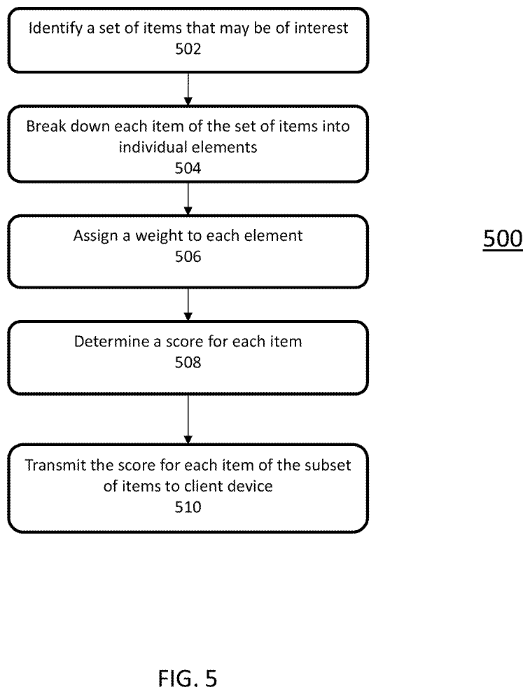

FIG. 5 is a flowchart illustrating a process for assigning a score to vehicles, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 5, as will be understood by a person of ordinary skill in the art.

Method 500 shall be described with reference to FIG. 1. However, method 500 is not limited to those example embodiments.

In operation 502, server 100 identifies a set of items that may be of interest to the user based on the user item ownership data and subjective data, as described in method 400. For example, server 100 may match elements of the user's currently and previously owned items with elements of a set of items that may be available for purchase for the user. Furthermore, server 100 may use the subjective data regarding the user's current and previously owned items to identify the user's likes or dislikes regarding elements of the user's current and previously owned items. Server 100 may use the user's likes or dislikes regarding the elements of the user's current and previously owned items to filter the set of items

In operation 504, server 100 separates each item of the set of items into individual elements. For example, the items may be vehicles, and the elements may be make, model, color, year, price, size, type, etc.

In operation 506, server 100 assigns a weight to each element. The weight indicates the importance of the element to the user. For example, server 100 may determine certain vehicle elements are more important to a user than others based on the user item ownership data and subjective data. In particular, server 100 may identify similarities across the user's current and previously owned vehicles. This may indicate the user's preferences when looking for a vehicle. Furthermore, server 100 may use the subjective data regarding the user's current and previously owned items to identify the user's preferences regarding elements of the user's current and previously owned items. Based on the user's preferences, server 100 may assign a weight to each element.

In operation 508, server 100 determines a score for each item of the set of items based on the closeness to an element of a respective item to the user's preferences and the weight assigned to the item. For example, the score indicates a likelihood that a user may purchase the vehicle. Server 100 determines that the user prefers vehicles around the size of a particular make. Thereafter, server 100 may determine that a score for vehicles around the same size as the particular make is higher than smaller or bigger cars. As indicated in method 400, server 100 may identify a subset of items from the set of items to identify a subset of items from the set of items based on the availability of the subset of items and the user information.

In operation 510, server 100 transmits the score for each item of the subset of items to client device 110. For example, client device 110 may be operated by a seller, such as a car dealership. The car dealership may use the information about the subset of vehicles and scores to determine whether a user is likely to purchase a given vehicle.

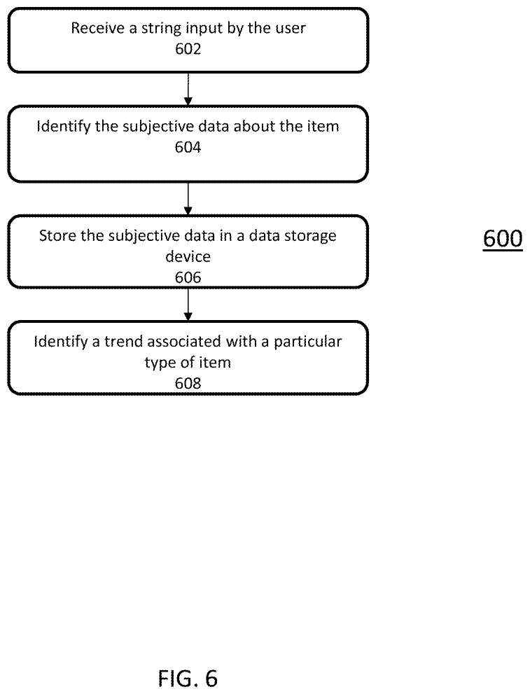

FIG. 6 is a flowchart illustrating a process for identifying a trend based on subjective data, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 6, as will be understood by a person of ordinary skill in the art.

Method 600 shall be described with reference to FIG. 1. However, method 600 is not limited to those example embodiments.

In operation 602, server 100 receives a string input by the user about the item owned by the user from the website. The string may include subjective data regarding the item owned by the user. For example, the string may be “Great car, but too small.”

In operation 604, server 100 identifies the subjective data about the item owned by the user from the string. Server 100 may use a NLP algorithm to identify the subjective data about the item. In particular, server 100 may use NLP to determine the user's sentiment regarding the item owned by the user. Server 100 may determine the user's likes and dislikes with respect to the user's current and previously owned items based on the subjective data.

In operation 606, server 100 stores the subjective data in data storage device 140-3. Data storage device 140-3 may store subjective data for other users regarding the other users' current and previously owned items.

In operation 608, server 100 identifies a trend associated with a particular type of item based on the subjective data stored in data storage device 140-3. For example, server 100 may determine that more than a threshold amount of users feel that a particular vehicle is not dependable, too small, or of bad quality. Moreover, server 100 may determine trends with the particular item in particular geographic locations. For example, server 100 may determine that users living in mountainous areas prefer vehicles built for off-roading based on the subjective data stored in data storage device 140-3.

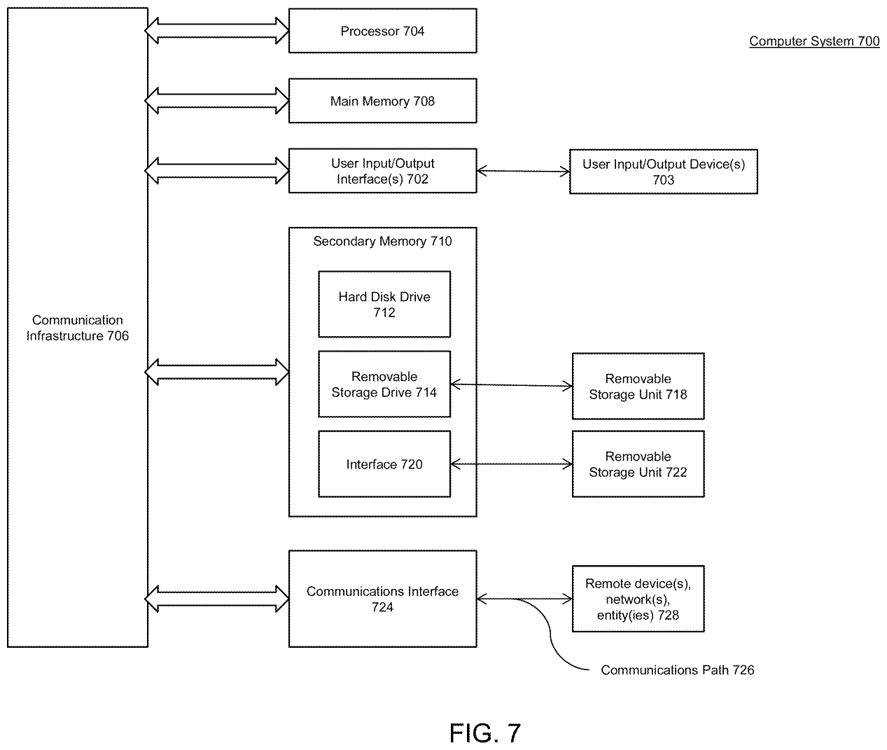

Various embodiments can be implemented, for example, using one or more computer systems, such as computer system 700 shown in FIG. 7. Computer system 700 can be used, for example, to implement methods 400 of FIG. 4, 500 of FIG. 5, and 600 of FIG. 6. Furthermore, computer system 700 can be at least part of server 100, client device 110, user device 120, database 140, and external system 142, as shown in FIG. 1. For example, computer system 700 route communication to various applications. Computer system 700 can be any computer capable of performing the functions described herein.

Computer system 700 can be any well-known computer capable of performing the functions described herein.

Computer system 700 includes one or more processors (also called central processing units, or CPUs), such as a processor 704. Processor 704 is connected to a communication infrastructure or bus 706.

One or more processors 704 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main or primary memory 708, such as random access memory (RAM). Main memory 708 can include one or more levels of cache. Main memory 708 has stored therein control logic (i.e., computer software) and/or data.

Computer system 700 can also include one or more secondary storage devices or memory 710. Secondary memory 710 can include, for example, a hard disk drive 712 and/or a removable storage device or drive 714. Removable storage drive 714 can be a floppy disk drive, a magnetic tape drive, a compact disk drive, an optical storage device, tape backup device, and/or any other storage device/drive.

Removable storage drive 714 can interact with a removable storage unit 718. Removable storage unit 718 includes a computer usable or readable storage device having stored thereon computer software (control logic) and/or data. Removable storage unit 718 can be a floppy disk, magnetic tape, compact disk, DVD, optical storage disk, and/any other computer database. Removable storage drive 714 reads from and/or writes to removable storage unit 718 in a well-known manner.

According to an exemplary embodiment, secondary memory 710 can include other means, instrumentalities, or other approaches for allowing computer programs and/or other instructions and/or data to be accessed by computer system 700. Such means, instrumentalities, or other approaches can include, for example, a removable storage unit 722 and an interface 720. Examples of the removable storage unit 722 and the interface 720 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 can further include a communication or network interface 724. Communication interface 724 enables computer system 700 to communicate and interact with any combination of remote devices, remote networks, remote entities, etc. (individually and collectively referenced by reference number 728). For example, communication interface 724 can allow computer system 700 to communicate with remote devices 728 over communications path 726, which can be wired and/or wireless, and which can include any combination of LANs, WANs, the Internet, etc. Control logic and/or data can be transmitted to and from computer system 700 via communication path 726.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
receiving, by one or more computing devices, item ownership data for a user and user information, wherein the item ownership data indicates an item currently or previously owned by the user;
receiving, by the one or more computing devices, a string about the item provided by the user;
identifying, by the one or more computing devices and from the string, subjective data about the item;
identifying, by the one or more computing devices, user preference data based on the item ownership data and the user information using a machine learning algorithm;
identifying, by the one or more computing devices, a set of items based on the item ownership data, the subjective data, and the user preference data;
determining, by the one or more computing devices, a subset of items from the set of items based on availability of the subset of items and the user information; and
transmitting, by the one or more computing devices, the identified subset of items to a device.

2. The method of claim 1, wherein the device is a user device, and the identified subset of items is a recommendation for the user.

3. The method of claim 1, wherein the device is a client device associated with a third-party where the subset of items are available.

4. The method of claim 1, further comprising identifying, by the one or more computing devices, text in the string, which indicates the subjective data about the item owned by the user, using a natural language processing algorithm.

5. The method of claim 1, further comprising:
parsing, by the one or more computing devices and using the machine-learning algorithm, each item of the set of items into a plurality of elements, wherein the user preference data corresponds to the plurality of elements;
assigning, by the one or more computing devices and using the machine-learning algorithm, a weight to each respective element of the plurality of elements based on the user preference data associated the respective element;
generating, by the one or more computing devices and using the machine-learning algorithm, a score for each item of the set of items based on the weight assigned to each element of the plurality of elements and a similarity of the respective element of a respective item to the user preference data regarding the respective element, the score indicating a likelihood the user will select the respective item from the set of items; and
transmitting, by the one or more computing devices, scores assigned to the subset of items to a third-party system.

6. The method of claim 1, further comprising determining, by the one or more computing devices, that the user is prequalified for the subset of items based on the user information.

7. The method of claim 1, further comprising:
storing, by the one or more computing devices, the subjective data in a data storage device and other subjective data from other users about other items currently or previously owned by the other users; and
identifying, by the one or more computing devices, a trend attribute about the item currently or previously owned by the user and the other items currently or previously owned by other users based on the subjective data and the other subjective data.

8. The method of claim 1, further comprising storing, by the one or more computing devices, information associated with the set of items in a database, wherein the subset of items is identified in response to a listener detecting the information being stored in the database.

9. The method of claim 1, further comprising:
detecting, by the one or more computing devices, authentication details of the user on a different website; and
causing, by the one or more computing devices, display of information of at least one item of the subset of items;

10. A system comprising:
a memory; and
a processor coupled to the memory, the processor configured to:
receive item ownership data for a user and user information, wherein the item ownership data indicates an item currently or previously owned by the user;
receive a string about the item provided by the user;
identify, from the string, subjective data about the item;
identify user preference data based on the item ownership data and the user information using a machine learning algorithm;
identify a set of items based on the item ownership data, the subjective data, and the user preference data;
determine a subset of items from the set of items based on availability of the subset of items and the user information; and
transmit the identified subset of items to a device.

11. The system of claim 10, wherein the device is a user device, and the subset of items is a recommendation for the user.

12. The system of claim 10, wherein the processor is further configured to identify text in the string, which indicates the subjective data about the item owned by the user using a natural language processing algorithm.

13. The system of claim 10, wherein the processor is further configured to:
parse, using the machine learning algorithm, each item of the set of items into a plurality of elements, wherein the user preference data corresponds to the plurality of elements;
assign, using the machine learning algorithm, a weight to each element of the plurality of elements based on the user's preferences regarding a respective element;
generate, using the machine-learning algorithm, a score for each item of the set of items based on the weight assigned to each element of the plurality of elements and a similarity of the respective element of a respective item to the user preference data regarding the respective element, the score indicating a likelihood the user will select the respective item from the set of items; and
transmit scores assigned to the subset of items to a third-party system.

14. The system of claim 10, wherein the processor is further configured to determine that the user is prequalified for the subset of items based on the user information.

15. The system of claim 10, wherein the processor is further configured to:
store the subjective data and other subjective data from other users about other items currently or previously owned by the other users in a data storage device; and
identify a trend attribute about the item currently or previously owned by the user and the other items currently or previously owned by other users based on the subjective data and the other subjective data.

16. The system of claim 10, wherein the processor is further configured to store information associated with the set of items in a database, wherein the subset of items is identified in response to a listener detecting the information being stored in the database.

17. The system of claim 10, wherein the processor is further configured to:
detect authentication details of the user on a different website; and
cause display of information of at least one item of the subset of items.

18. A non-transitory computer-readable medium having instructions stored thereon, execution of which, by one or more processors of a device, cause the one or more processors to perform operations comprising:
receiving item ownership data for a user and user information, wherein the item ownership data indicates an item currently or previously owned by the user;
receiving a string about the item provided by the user;
identifying, from the string, subjective data about the item;
identifying, using a machine-learning algorithm, user preference data using the item ownership data and the user information;
identifying a set of items based on the item ownership data, the subjective data, and the user preference data;
detecting a subset of items from the set of items based on availability of the subset of items and the user information; and
transmitting the identified subset of items to a device.

19. The non-transitory computer-readable medium of claim 18, wherein the operations further comprise: identifying text in the string, which indicates the subjective data about the item owned by the user using a natural language processing algorithm.

20. The non-transitory computer-readable medium of claim 18, wherein the operations further comprise:
parsing, using the machine-learning algorithm, each item of the set of items into a plurality of elements, wherein the user preference data corresponds to the plurality of elements;
assigning, using the machine-learning algorithm, a weight to each element of the plurality of elements based on the user's preferences regarding a respective element;
generating, using the machine-learning algorithm, a score for each item of the set of items based on the weight assigned to each element of the plurality of elements and a similarity of the respective element of a respective item to the user preference data regarding the respective element, the score indicating a likelihood the user will select the respective item from the set of items; and
transmitting scores assigned to the subset of items to a third-party system.
